(19) United States
(12) Patent Application Publication
(10) Pub. No.: US 2001/0037506 A1
(43) Pub. Date: Nov. 1, 2001

(54) Method for streaming interactive content products

(76) Inventor: Norton Garfinkle, New York, NY (US)

Correspondence Address: VENABLE, BAETJER, HOWARD AND CIVILETTI, LLP, P.O. BOX 34385, WASHINGTON, DC, 20043-9998, US

(21) Appl. No.: 09/863,395

(22) Filed: May 24, 2001

(30) Foreign Application Priority Data
Nov. 24, 1998 (US) PCT/US98/25043

(51) Int. Cl. G06F 3/00; H04N 7/16

(52) U.S. Cl. 725/60; 725/1

(57) ABSTRACT

A pay-per-use system streams a data product from a head end to one or more users allowing interactive, discontinuous use by establishing a user terminal address memory location at the head end in response to each initial pay-per-use request. The system starts playing the movie on an available channel and enables the user to view the feature. The system stores associatively with the user address a limit on the user's use of the requested product; in a specific embodiment a time period during which the movie can be viewed, or the number of times the movie can be viewed, or both, even though the data transmission channel between the user and head end is not in use continuously.

### BACKGROUND OF THE INVENTION

1. Field of the Invention

This invention relates to an improved pay-for-use system for digitally streamed content products (e.g. movies, educational products, music or other audio content) on demand from a head end to a plurality of user sites, and more particularly to a system which provides the user with interactive control of the product while at the same time providing a limit on use.

2. Description of the Prior Art

In general, the mechanics of allowing a plurality of users to interactively view and listen to a data product streamed from a head end is known in the prior art. For example, U.S. Pat. No. 5,051,822 discloses a digital, interactive communication system designed to provide a plurality of remote subscribers with any one of a plurality of stored video games or like software packages through the use of a home computing assembly maintained within the subscriber's home and structured to display video as well as generating audio on a standard television receiver. A bi-directional communication link is established over telephone lines between the home computing assembly and the central remote game storage center wherein the software programs are transmitted as a modulated carrier to the subscriber. Program selection is controlled by a remote game storage center executive software program. Automatic billing is performed by computing equipment maintained in the remote game storage center and transmitted to a headquarters. This prior art system contemplates continuous interactive use of the product. In such prior art systems, generally, after the run time for the product has elapsed, the product automatically stops, the system disables the user and the transmission channel bandwidth (real or virtual) that was used is available for others. Since such prior on-demand streaming systems do not allow products to be paused, skipped forward, or rewound, and the like, the matter of run times and channel availability is a straightforward one.

U.S. Pat. No. 5,400,402 ('402) (incorporated herein by reference) entitled System for Limiting Use of Down-Loaded Video-On-Demand Data, invented by the inventor of this application, and assigned for the assignees of this application, describes a system for controlling the use of digital products (e.g. video and audio entertainment products), which have been down-loaded on demand from a head end to storage at a user site. In that invention, a control system at the customer site operates independently of the central station once the program has been down-loaded. In one embodiment, the control system erases or scrambles the stored program after it has been viewed a predetermined number of times (e.g., once), and in another embodiment the program is erased or scrambled after a predetermined interval (e.g., 24 hours). In one embodiment the stored program is erased after a predetermined interval or after a predetermined number of accesses or any combination thereof based on fixed criteria stored at the customer site. In another embodiment, the downloaded data includes instructions that specify and controls the number of times the stored data may be accessed, or the period during which the stored material may be accessed, or any combination thereof. In each embodiment, a control system limits further access to the stored program after the limit has been reached.

### SUMMARY OF THE INVENTION

An object of this invention is the provision of a pay-per-use, on demand, system for streamed digital products that limits use of the products but allows discontinuous use.

Briefly, this invention contemplates the provision of a pay-per-use system that streams a data product from a head end to one or more users allowing interactive, discontinuous use by establishing a user terminal address memory location at the head end in response to each initial pay-per-use request. In the contemplated on-demand streaming system, in one embodiment of the invention movies are accounted for and movie run times are handled in a down-loaded movie initialization file that holds information about all of the movies currently loaded in the head end system. This file contains the titles, ratings, costs, hard disk file names and run times associated with each movie, along with other movie tracking information. New movies are independently down-loaded into the head end hard drive. When a user orders a movie, the movie initialization file is used to retrieve the run time and the computer file name of the movie. The system starts playing the movie on an available channel and enables the user to view the feature. The system stores associatively with the user address a limit on the user's use of the requested product; in a specific embodiment a time period during which the movie can be viewed, or the number of times the movie can be viewed, or both, even though the data transmission channel between the user and head end is not in use continuously.

### BRIEF DESCRIPTION OF THE DRAWINGS

The foregoing and other objects, aspects and advantages will be better understood from the following detailed description of a preferred embodiment of the invention, in which:

FIG. 1 is a functional block diagram of one exemplary embodiment of the invention.

### DETAILED DESCRIPTION OF A PREFERRED EMBODIMENT

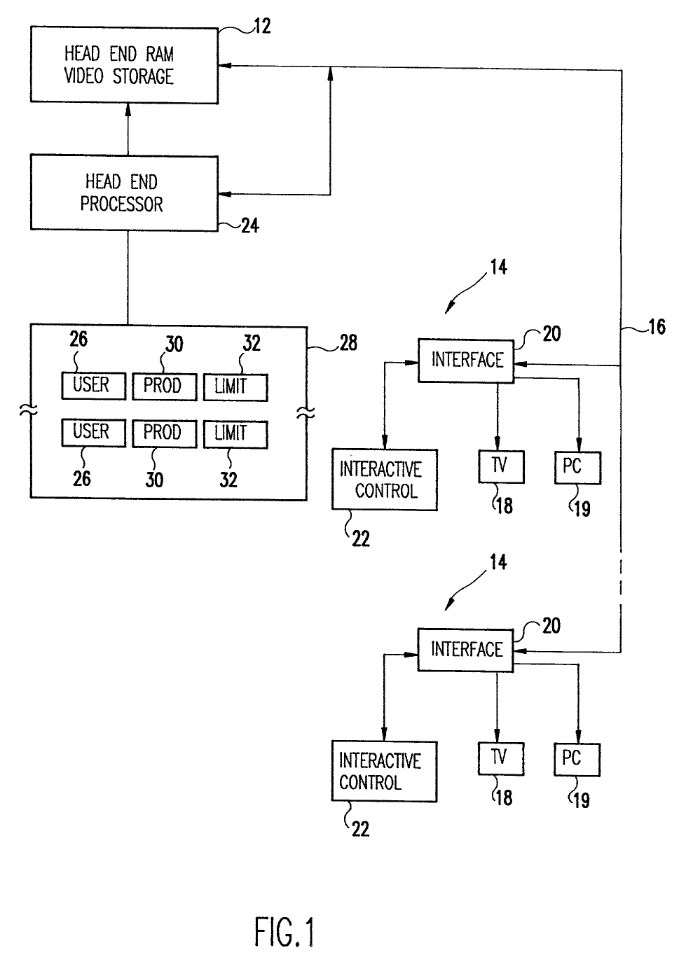

Referring now to FIG. 1, a head end of a suitable design known in the art includes a random access memory 12 which can stream simultaneously a digital data product, such as a movie recorded on a disk, on demand to a number of sites 14 connected to the head end by a two-way communications link 16. Here it will be appreciated that commercially available technology, such as that described above in connection with the background of this invention, allows head end real time transmission from a randomly accessible record of different segments of the record to a number of different user addresses. This allows the data to be transmitted as a real time data stream on demand to each of the users. That is, the real time data stream for each user is independent of the data stream simultaneously transmitted to other users from the same head end record so that each data stream can be started, stopped, and, additionally, interactively controlled independently of each other data stream even though each stream is derived from the same head end data record.

The communications link 16 may be, for example, a cable link, a satellite link, a fiber optic link, a telephone link or other suitable link or combination of links employing different technologies, which allow communication between the head end and the user site and between the user site and the head end. The user site includes a TV 18 and/or computer 19 and a communications interface 20 either internal or external to the TV 18 or computer 19 for converting the digital data stream to video and audio signals compatible with the TV 18 and for coupling command signals from an interactive controller 22 to the communications link 16 for transmission to the head end processor 24. The communications interface 20 includes an address interface that allows it to decode and couple to the TV 18 and/or computer 19 those parts of the digital data stream addressed to it and to encode and insert its address in user control commands transmitted to the head end processor 24.

The interactive controller 22 either internal or external to the TV 18 or computer 19 also is programmed to provide function command codes, such as stop, start, rewind, fast forward, and the like, that are interpreted and acted upon by the processor 24. In addition, the digital product may include ancillary features which can be selected for viewing, such as for example, critical reviews and commentaries relative to the product.

The head end processor 24 performs prior art control, accounting, and billing functions. A user input, ordering a product from the head end, includes the user address, which the processor 24 converts to a user identification 26, which it stores im memory 28. The head end processor associates in the user file 26 in memory 28 a product code 30 so that the processor can respond to interactive user commands such as, for example, stop commands, rewind commands, move to ancillary material commands, and restart commands.

The processor 24 also generates a use limit code 32 dependent upon the product ordered and/or any use option offered by the system and selected by the user. This allows a fixed charge for the product, known to the user at the time he or she orders the product, consistent with any license agreement with respect to the product based on use, while at the same time allowing interactivity between the user and the product within the limit set by the processor. In a specific embodiment of the invention the limit is a set period of clock time, for example twenty-four hours. Here, the processor stores a value equal to the set period (e.g. twenty-four hours) associated in the memory with the user address. The processor 24 starts transmitting the product ordered as a data stream from the RAM storage 12, inserting the address code of the user who ordered the product. A processor clock decrements the set period, and, at the end of the period, when the memory address is periodically read, the decremented value is interpreted by the processor 24 as a signal to stop further transmission of the product to that address.

While the invention has been described in terms of a single preferred embodiment, those skilled in the art will recognize that the invention can be practiced with modification within the spirit and scope of the appended claim.

1. A method for delivering an on-demand content product from a head end to a plurality of remote users in which each of the users interactively controls the product from a product record, including the steps of:
storing at said head end said product in a random access memory;
storing in memory an address of each user associatively with an identifier code of said content product and a use limit value;
addressing said random access memory in a sequence respectively dictated by control signals generated by each of said plurality of users in order to generate a data stream of said product particularized to interactive control signals generated by each of said plurality of users including control signals to stop and start said data stream;
transmitting said data stream to each of said plurality of users;
blocking transmission of said data stream to a user when the use limit value stored in said storing step is reached or exceeded.

2. A method for delivering an on-demand content product from a head end to a plurality of remote users in which each of the users interactively controls the product, including the steps of:
storing at said head end said product in a random access memory;
storing in memory an address of each user associatively with an identifier code of said content product and a use limit value;
addressing said random access memory in a sequence respectively dictated by control signals generated by each of said plurality of users in order to generate a data stream of said product responsive to interactive control signals generated by each of said plurality of users including control signals to stop and start said data stream;
transmitting said data stream to each of said plurality of users;
blocking access to said data stream to a user when the use limit value stored in said storing step is reached or exceeded.

3. A method as in claim 1 wherein said limit value establishes an elapsed time limit.

4. A method as in claim 2 wherein said limit value establishes an elapsed time limit.
